(19) United States
(12) Patent Application Publication
(10) Pub. No.: US 2013/0124262 A1
(43) Pub. Date: May 16, 2013

(54) CROSS CHANNEL EXPLICIT FEEDBACK AND CORRECTIVE ACTION FRAMEWORK

(71) Applicant: Arvindeep Singh Anchala, Cumming, GA (US)

(72) Inventor: Arvindeep Singh Anchala, Cumming, GA (US)

(73) Assignee: Cellco Partnership d/b/a Verizon Wireless, Basking Ridge, NJ (US)

(21) Appl. No.: 13/294,882

(22) Filed: Nov. 11, 2011

(51) Int. Cl. G06Q 30/02

(52) U.S. Cl. 705/7.32

(57) ABSTRACT

Techniques and equipment for enabling a cross-channel feedback loop for capturing, in an interactive customer retail or service channel of a business enterprise, explicit feedback from a user for a similar or related transaction initiated by the user in a different channel. The explicit user feedback captured in the second channel can be used to evaluate and, if desired, make improvements to user interface components related to self-service or automated user transactions in the first channel.

### BACKGROUND

An enterprise offering goods and/or services to consumers will often operate systems providing different channels and user interfaces, for enterprise interaction with consumers. The interactive channels may be for initial sales to new customers, sales to existing customers, service to existing customers, etc. For example, an enterprise offering mobile communication devices and services to the public may operate systems and provide various interactive channels for customer sales and services including, but not limited to, an on-line Web Channel for consumers, an in-store Retail Channel; an interactive voice response (IVR) Channel; a live operator Tele Sales Channel; a Handset Channel for access via mobile device as well as others such as an automated Kiosk Channel, etc.

These various consumer interaction channels for an enterprise organization generally use disparate systems and provide different interfaces from the consumers' perspective. Consequently, it is difficult to capture information about a customer's activity or transaction via one such channel within the enterprise organization and use this information in another sales channel. It is also difficult to capture feedback about the channels, for enterprise improvement of the user interfaces. The lack of awareness of customer activity between channels leads to poor allocation of resources for channel improvement, i.e., improving customer service for any particular sales channel. The lack of explicit feedback from the customer (e.g., as to why a transaction in one channel was cancelled) leads to lost opportunities for the organization.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary enterprise environment offering a variety of communication services, including communications for a corrective action framework based on explicit user feedback across different customer channels.

FIG. 2 is a flowchart of an exemplary high-level process for implementing a corrective action framework based on explicit user feedback in the enterprise environment of FIG. 1.

FIG. 3 is a block diagram of an exemplary data server for generating customer segments in a corrective action framework based on explicit user feedback.

FIG. 4 is a flowchart of an exemplary process for identifying a user based on a unique global identifier assigned to the user in the enterprise environment.

FIG. 5 is a flowchart of an exemplary process for monitoring and improving production metrics based on a modified user interface based explicit customer feedback for a targeted customer segment.

FIG. 6 is a simplified functional block diagram of an exemplary computer that may be configured to host a self-service transaction, for example, to function as a server in the system of FIG. 1.

FIG. 7 is a simplified functional block diagram of an exemplary personal computer or other user device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The drawings and discussions below relate to examples of techniques and equipment for enabling a cross-channel feedback loop and corrective action framework for capturing, in a second channel (e.g., telesales or customer service) of an enterprise organization, explicit feedback from a user about a similar or closely related transaction in a first channel (e.g., online or Web retail channel). Examples of such related transactions from one channel to another include, but are not limited to, transactions from the first channel that were abandoned or have an incomplete status, and repeat transactions involving the same or a similar type of transaction initiated in another channel within a relatively short period of time of the first transaction. The explicit user feedback captured in the second channel can then be used to make adjustments, modifications or improvements to user interface elements or enterprise system components related to user experience for self-service or automated user transactions in the first channel.

The terms “interface” and “user interface” are used interchangeably herein to refer broadly and inclusively to any form of interactive communication to and from a user (or customer) of an enterprise organization. Such a user interface may include, for example and without limitation, an interactive voice response interface (e.g., an automated response system with speech-to-text transcription capabilities), an automated digital or electronic interface including interactive visual elements (e.g., a web portal or other interactive visual interface provided via one or more web pages or screens loaded from a server through a communication network to the user's web browser or other application on the user's device), and a live person interface (e.g., a customer service representative or an automated speech-to-text conversion tool in a call center). Further, it should be noted that any adjustment or modification to such a user interface may involve modification(s) to front-end interface components of an enterprise system, to back-end components or operations of such system, or to both. As such, a different user experience may be provided to the user by modifying one or more such components or operations associated with either front-end or back-end processes or systems in an enterprise network environment.

The terms “channel” and “interactive channel” are used interchangeably herein to refer broadly and inclusively to any interactive communication channel of an enterprise organization through which a user may request one or more products or services offered by the enterprise or information related to such products or services. For example, the enterprise may be a commercial or non-commercial enterprise, and the interactive communication channels of the enterprise thus may be used for either commercial or non-commercial purposes, depending on the particular type of enterprise organization. In an example, a business or commercial enterprise may include different channels for retail or sales purposes (or “sales channels”) and other channels for customer service and support purposes.

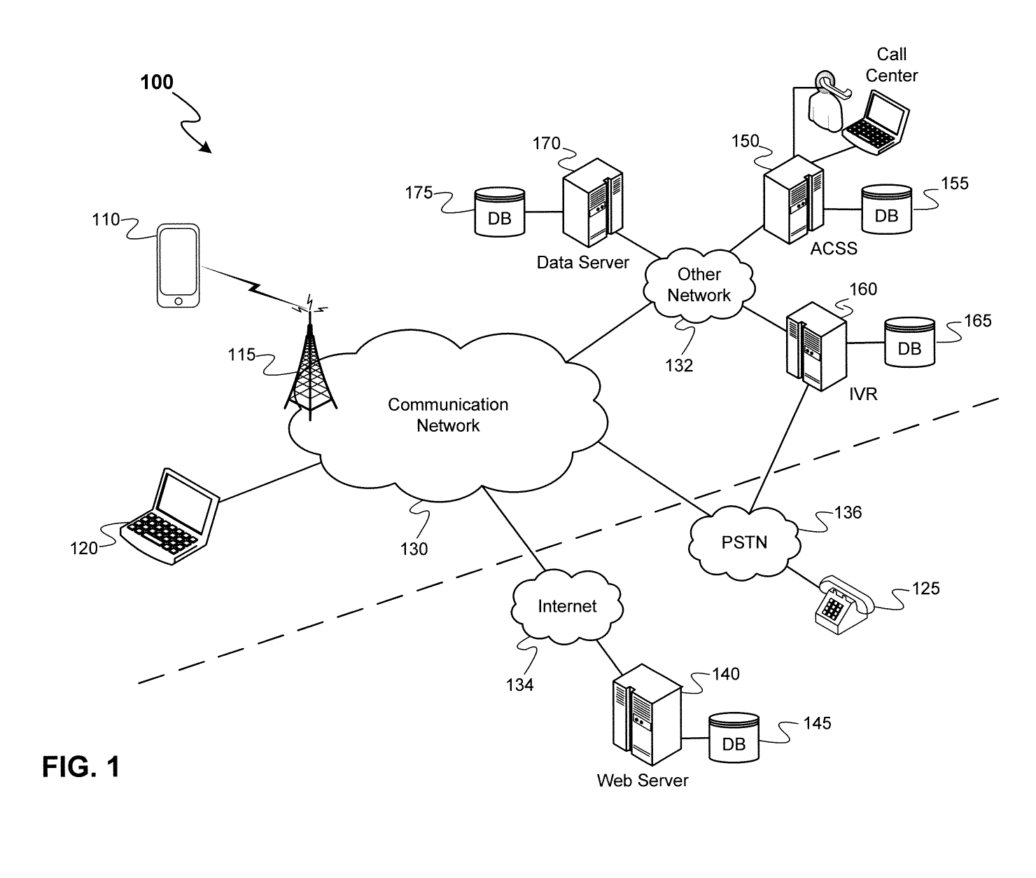

Reference now is made in detail to the examples illustrated in the accompanying drawings and discussed below. An exemplary enterprise network environment 100 is described initially with respect to FIG. 1. By way of illustration, the enterprise in our example operates a mobile communication network and offers its users and potential users (i.e., customers) communication services as well as other services marketed and/or provided through the network. For example, the communication network 130 may be implemented as a network conforming to one or more well-known wireless networking standards and protocols. Examples of such standards include, but are not limited to, the code division multiple access (CDMA) IS-95 standard, the 3rd Generation Partnership Project (3GPP) wireless IP network standard, the 3rd Generation Partnership Project 2 (3GPP2) wireless IP network standard, the Evolution Data Optimized (EVDO) standard, the Global System for Mobile (GSM) communication standard, the time division multiple access (TDMA) standard or other standards used for public mobile wireless communications.

However, it should be noted that the cross-channel feedback loop and corrective action framework as described herein is not intended to be limited to mobile communication networks and therefore, may be applied to interactive communication channels of other types of enterprise organizations. As noted above, such channels may be designated for retail sales, customer service, or other customer support purposes. Further, the channels can be used to conduct sales or service transactions for new users or existing users having accounts with the enterprise. It should also be noted that such communication channels may be used for commercial or non-commercial purposes, depending on the particular enterprise organization. Hence, the illustrated enterprise environment provides a variety of communication services between different user devices and enterprise servers, including communications for tracking explicit user feedback across different channels of an enterprise in a corrective action framework.

As will be described in further detail below, such a corrective action framework is associated with various interactive channels of an enterprise. Examples of such interactive channels include, but are not limited to, an on-line Web channel for retail consumers, an in-store retail channel, an interactive voice response (IVR) channel (e.g., as will be described in further detail below with respect to server 160 and database 165), a customer service channel including a call center, a live-person chat channel and telephone sales, a handset channel for access via a mobile device, and even automated channels such as an automated Kiosk channel and an automated chat channel (e.g., involving pre-defined answers to frequently asked questions, without any live-person interaction). For example, each of the different sales or interactive channels within the organization may be associated with a different system for providing self-service transactions to various users and managing user data. However, as will be described in further detail below, the corrective action framework enables these systems to detect and track cross-channel user behavior in substantially real time so as to create new business opportunities and improve customer experience for the organization as a whole.

In the example illustrated in FIG. 1, enterprise environment 100 includes a client device 110 and a client device 120, which communicate request messages to one or more servers 140, 150, 160 and 170 through a communication network 130, which can include, for example, one or more interconnected networks such as a network 132 and the Internet 134. Also, as shown in FIG. 1, servers 140, 150, 160 and 170 are each communicatively coupled to a database 145, a database 155, a database 165 and a database 175, respectively. In an example, servers 140, 150, and 160, including their respective databases 145, 155 and 165, are each associated with a different enterprise channel. As shown in the example of FIG. 1, server 140 may be a web server in an interactive online channel of the enterprise. As will be described in further detail below, servers 150 and 160 may represent servers in an Interactive Voice Response (IVR) system and an Automated Customer Support System (ACSS) arranged at a call center, respectively. Further, each of databases 145, 155, 165 and 175 may be accessible to any of servers 140, 150, 160 and 170 for accessing user transaction data across the various channels, as will be described in further detail below, via communication network 130 (including network 132). In particular, data server 170 and database 175 in this example are part of a data warehouse system for storing, processing, and sharing such user transaction data across the various channels of the enterprise environment 100.

Communication network 130 of enterprise environment 100 facilitates communications between various types of clients and at least one server for purposes of client access to the functionality of a service hosted at the server. Such functionality can be implemented in the form of a self-service transaction accessible to the client. In addition, network 130 further supports communications for devices that do not execute client applications or participate in any particular service hosted at any of servers 140. Network 130 can thus be any network or combination of networks in an overall communication network for transmitting voice and types of data communications between various devices associated with the communication network. Network 130 can include, but is not limited to, a wired (e.g., Ethernet) or a wireless (e.g., Wi-Fi or 4G) network. In addition, network 130 can include a local area network, medium area network, and/or wide area network. Network 130 can support protocols and technology including, but not limited to, Internet or World Wide Web protocols and communication services. Intermediate network routers, gateways, or servers may be provided between components of enterprise environment 100 as may be necessary depending upon a particular network implementation or computing environment.

In an example, communication network 130 allows users of client devices 110 and 120 (and other devices not shown) to initiate and receive telephone calls to each other as well as through the public switched telephone network or “PSTN” 136 and a telephone station 125 connected to the PSTN. Additionally, network 130 enables users to request various data services via the Internet 134, such as downloads, web browsing, email, and other similar types of web services. Such data services are hosted at one or more application servers (e.g., web server 140) associated with network 130. As communication network 130 of enterprise environment 100 can be implemented using a number of interconnected networks, the overall network for the enterprise environment may include a number of radio access networks (RANs). Such radio access networks can also include a traffic network for transferring user communications and data, e.g., from mobile device 110 to base station 115 and other elements with or through which mobile device 110 communicates. The network can also include other elements that support functionality other than device-to-device media transfer services such as messaging service messages and voice communications. Specific elements of communication network 130 for carrying the voice and data traffic and for controlling various aspects of the calls or sessions are omitted here for simplicity.

The client devices 110 and 120 are examples of two types of client devices that may be used for communicating request messages to a web service hosted at one or more of server(s) 140. In the example shown in FIG. 1, client device 110 is a mobile station or device for accessing mobile wireless communications services through communication network 130, for example, via one or more base stations (BSs) 115. Thus, client device 110 can be any type of mobile computing device capable of sending and receiving voice and data communications over one or more networks. Examples of such mobile computing devices include, but are not limited to, portable handsets, smart-phones, tablet computers, and personal digital assistants. Similarly, client device 120 can be any type of general purpose computing device, such as a desktop personal computer. An exemplary implementation of such client devices capable of implementing a client will be described further below with respect to FIG. 7.

While the example in FIG. 1 shows only two client devices 110 and 120, enterprise environment 100 can be used to facilitate data communications for additional devices (not shown) over communication network 130. Similarly, enterprise environment 100 can include other servers in addition to servers 140, 150, 160 and 170 for receiving request messages from one or more of the client devices. Furthermore, the present techniques may be implemented in communication network 130 using any of a variety of available communication networks and/or on any type of computing device compatible with such a network. As such, FIG. 1 is used herein to provide only a very simplified example of a few relevant elements of enterprise environment 100 and network 130, for purposes of discussion and ease of explanation.

In an example, a user of a mobile device (e.g., client device 110) can dial a predetermined number, such as a customer service number, to reach an Interactive Voice Response system (IVR) 160, as noted above. IVR 160 may provide one or more selected items of information to the user (also referred to as the caller in this example), or route the call to a call center per the user's request. Once the call reaches the call center, an agent speaks to the customer to resolve her need. IVR 160 interacts with the caller by collecting the caller's inputs entered using a telephone keypad and responding with voice. For example, when the caller dials a customer service number, IVR 160 may provide an automated interface for greeting the caller with audio content and guiding the user via audio prompts in a step-by-step transaction. Each step of this transaction provides the caller with various options (e.g., pressing different input keys to request the user's account information or some other information or service provided by the enterprise). In response to user input (e.g., when the user presses a key on a keypad of the device), the IVR 160 may respond with an audio response based on the particular input (e.g., particular key that was pressed by the user).

Per the caller's request, a call can be transferred to a call center to enable the caller to speak with a live person. While a call is delivered to the call center, one business objective is on completing the call as quickly as possible. This is typically measured by the average handling time (AHT) for each live agent at the call center. In order to help the agent to meet this objective, information collected in the IVR system is delivered to the live agent. In an example, each menu and option provided by IVR 160 may be associated with a unique code for the particular menu and option. When a caller interacts with the IVR system, the caller's actions can be identified by activity identifications (IDs) that represent codes of the menus and options selected by the caller.

As noted above, an Automated Customer Support System (ACSS) 150 arranged at the call center can translate user actions/activities into a readable text which is then displayed by the agent's desktop terminal when the agent communicates with the caller. For example, the automated customer service interface provided by the ACSS may allow the user to initiate a transaction by performing a series of actions or steps. Further, each action may be associated with an action or activity ID that uniquely identifies each action performed by the user, including the last action of the user for a transaction that, for example, was abandoned prior to completion. For example, the ACSS 150 may translate user transaction information into readable text indicating the last location in the system flow of IVR 160 that was reached by the caller before the call was transferred to the call center. In an example, the user activity or action data captured by IVR 160 and ACSS 150 for each transaction may be stored in database 165 and database 155, respectively. Alternatively, this information may be stored in a single database, for example, either database 155 or database 165, or at database 175 of the data warehouse system of the enterprise environment 100.

As noted above, enterprise environment 100 as illustrated in FIG. 1 can be used to provide a variety of communications, including communications for tracking explicit user feedback between different sales channels in a corrective action framework. For example, client devices 110 and 120 can each be configured to execute one or more web browser(s) or other client application for communicating with on one or more of servers 140 through network(s) 130. Further, server(s) 140 can be a web server that is configured to provide the user at client device 110 or 120 a user interface for initiating automated or self-service transactions via the web browser through a local area network or wide area network such as the Internet (134). For example, such self-service transactions may be associated with a Web or online retail sales channel of a business enterprise, as noted above. Further, such transactions may be for the purchase of one or more products or services offered to consumers by the business enterprise.

In an example, such a user transaction involves multiple steps or actions to be performed by the user in order to complete the transaction. For example, these steps or actions may be presented to the user as a series of virtual pages or screens, where each page corresponds to a different step/action in a series of steps/actions in a path to transaction completion. Accordingly, a transaction may considered to be “abandoned” when, for example, the user cancels or discontinues the transaction after one or more actions/steps are performed or completed but prior to the completion of the final step. In an example, databases 145, 155, 165, and 175 are used to store data corresponding to different user transactions associated with various interactive channels within the enterprise organization. In an example, server 140 captures transaction data corresponding to a self-service transaction for a user in a first sales channel (e.g., Web or online channel). Further, server 140 stores the captured data in real-time to database 145. For example, database 145 may be associated with a system in the first sales channel. The captured transaction data may include, for example, a set of actions taken by the user in association with one or more recent transactions, including any abandoned transaction, within some relevant time frame. For example, the relevant time frame may be some predetermined period of time for tracking user transaction data within the enterprise network environment 100. This period of time may be adjusted as desired to ensure that any transaction data that is captured and stored for the user remains relevant for a current transaction. Further, limiting the transaction data that is stored or maintained for a user to a temporary duration (e.g., period of three days) helps to conserve storage space in the enterprise network.

It should be noted that the techniques disclosed herein are not limited to incomplete or abandoned transactions. As described above, examples of other relevant transactions associated with the user in the first channel may include, but are not limited to, repeat transactions involving the same user initiating the same or a similar type of transaction in different channels within a relatively short period of time (e.g., within a few minutes or a few days of the first transaction initiated in the first channel). For example, the transaction in question may have been completed by the user in the first channel, but perhaps due to some unsatisfactory result or lingering question (e.g., confirmation of a completed payment transaction), the user initiates a second transaction in the second channel that is related to the first transaction within a relatively short period of time after completing the first transaction. In this example, the related transaction in question may be the same or similar type of transaction. For example, the user may have initiated a second transaction in the second channel requesting a change to the first transaction in the first channel, immediately after completing the first transaction.

Therefore, transaction data associated with the user's transaction in the first channel, in this example, may include a timestamp indicating when the transaction was completed. However, an explicit timestamp may not be used for each transaction when, for example, the systems of the enterprise environment are configured to store transaction data associated with a user for only a relatively short period of time (e.g., three days), which may be predetermined by the enterprise as desired. In an example, when the user initiates the subsequent transaction in the second channel (e.g., customer service or call center channel) and the second channel detects the occurrence of a relatively recent transaction (e.g., within the predetermined period of time) associated with the user's actions in a different channel, the user may be prompted either through an automated or live-person interface of the second channel to indicate whether the new transaction is related to the first transaction. Alternatively, such indication of a related transaction from the user may be a result of one or more user-selected options in an interactive menu provided through, e.g., the IVR 160 and/or ACSS 150, as described above. In an example, the stored transaction data for the user may correspond to a set of transactions initiated or completed by the user within the predetermined time period in the first channel. However, only the most relevant transaction will be selected from the set of transactions. A transaction may be considered relevant if it was abandoned by the user in the first channel or if it is closely related to the present transaction of the user in the second channel, and occurring within some predetermined time period, as described above. If more than one transaction is determined to be relevant, the most recent transaction may be selected. Additionally, the most relevant or closely related action from the set of actions corresponding to the relevant transaction is also selected based on the user's current actions in the second channel (e.g., the user's responses to an automated interface of IVR 160 or ACSS 150), as described above.

Similarly, transaction data for a user in a second channel of the organization may be stored by server 150 to database 155, as will be described in further detail below. The occurrence of a transaction in the first channel can be detected in the second channel by tracking the stored user transaction data from the first channel. In particular, the stored data may be tracked for a user based on a unique identifier that is shared between the channels. For example, such a unique identifier may be associated with the user (or user's device) and the stored transaction data for the user based on the user's interaction with one or more channels of the enterprise. Examples of different types of unique identifiers that may be used include, but are not limited to, a telephone number, user login identifier, or account number associated with the user. Alternatively, if such user account information is not immediately available for the particular user, a global identifier may be generated and assigned for identifying the user's device or browser or other application on the device through which the user initiates the relevant transaction request(s). The use of such a global identifier will be described in further detail below.

In an example, upon detection, in the second channel, of the occurrence of one or more actions of the user corresponding to a relevant transaction (e.g., abandoned or completed but unsatisfactory transaction, as described above) in the first channel, the stored set of actions and other data in database 145 can be shared, for example, via a back end system of communication network 130 to database 155 associated with the second channel. Alternatively, the most recent set of actions of the user may be stored within a user action table of another database (not shown) that is accessible across the different channels in an enterprise communication network, and retrieved in a particular channel when a relevant or closely related action is detected, as described above.

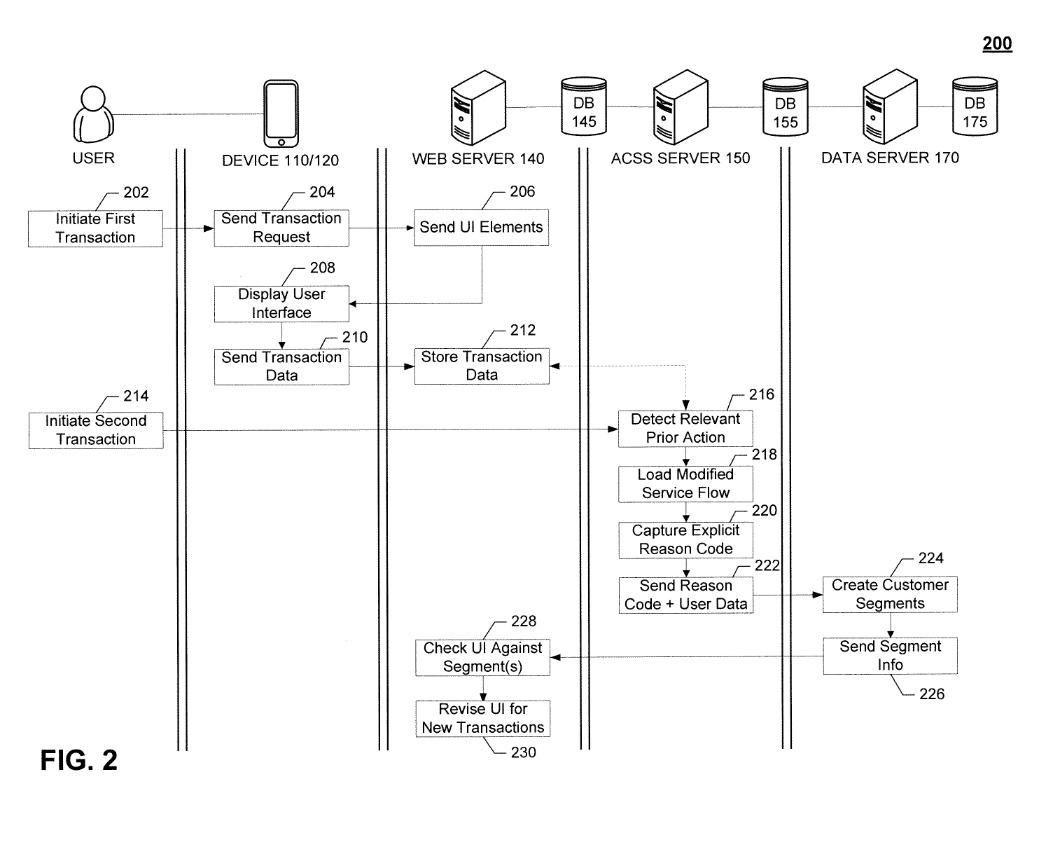

Reference is now made to FIG. 2 in order to further illustrate the functions performed by each of the components in the enterprise environment 100 of FIG. 1, as described above. The flowchart shown in FIG. 2 illustrates an exemplary high-level process 200 for implementing a corrective action framework in the enterprise environment based on explicit user feedback that is tracked between different user interface/interaction channels of the enterprise organization. For purposes of this example and the discussion below, process 200 will be described in the context of a commercial business enterprise in which a Web or online retail channel of the business enterprise is used as a first channel and a Call Center or Customer Service channel of the enterprise as a second channel. However, it is noted that the techniques disclosed herein are not intended to be limited thereto. In the example shown in FIG. 2, a set of actions of a user associated with a relevant self-service transaction occurring in a first channel (e.g., Web sales channel) of a business enterprise is detected in a second channel (e.g., Call Center or Customer Service) when the user contacts or interfaces with the second channel. A relevant transaction from the first channel may include, for example, any transaction that was abandoned or any transaction that is closely related to the present transaction of the user in the second channel and occurring within some predetermined time period, as described above. As described above, a user transaction may be considered abandoned when, for example, the transaction involves multiple steps and the user cancels or ends the transaction prior to the completion of the final step, e.g., either deliberately or due to the connection being inadvertently terminated.

Thus, process 200 as illustrated in FIG. 2 begins in step 202, in which the user initiates a first self-service transaction. For example, the user may initiate this transaction by operating the user's device (e.g., client device 110 or 120) to browse to a web page provided by the business enterprise for the sale of products and services. In response, the user device via the web browser may send a transaction request to the web server in step 204. In step 206, the web server sends user interface elements and other web page content to enable the user to perform the requested self-service transaction. For example, the information sent by the web server for the self-service transaction may include multiple web pages or frames with interactive content to be displayed on a display screen of the user device for further selection or data input to navigate to subsequent pages (step 208). Further, each web page or frame may correspond to a different step of the multi-step transaction. Transaction data associated with the user-initiated transaction is sent from the user device to the web server in step 210, for one or more actions performed by the user towards possible completion of a particular one of the enterprise transactions supported by the web server 140. The web server 140 stores the received transaction data in step 212. For example, the data may be stored in database 145.

In an example, however, the user for some reason does not complete the transaction. The user may have completed one or more actions, but not all of the actions for the particular transaction. The captured transaction data includes information identifying the last action of the user in the abandoned transaction through the first channel, which in this case corresponds to the user's online interaction with the web server 140. For example, the last action information may include information identifying a trail of web pages or frames browsed by the user at the user device. Such page trail data may further include the last web page or frame the user was viewing prior to abandoning the transaction. Additionally, this information may include the last user interface element of the last page the user may have selected or for which the user provided input prior to discontinuing the self-service transaction. As described above, data corresponding to the self-service transaction in the first sales channel, including the set of actions taken in an abandoned transaction, for the particular user is captured and stored in real-time to database 145.

In step 214, the same user initiates a second transaction in a second channel of the enterprise. For example, the second channel may be a call center for telephone sales and customer service. It should be noted that the techniques disclosed herein are not limited to retail channels involving the Web or telephone sales and support, and that the techniques may be applied across any of the various channels of an enterprise organization, as described above. Also, as noted above, the cross-channel feedback and awareness framework as described herein is not intended to be limited to commercial enterprises and therefore, may be applied to any type of enterprise organization. As such, any references to “customer” or “customer segments” in this example or other examples described herein may also refer to a user or user segment, respectively in a non-commercial enterprise. With respect to the call center example, the user/customer may be initiating the second transaction due to one or more issues that the user experienced while attempting to complete the first self-service transaction using the automated interface (e.g., step 208) associated with the first channel. Thus, the second transaction may be initiated using any telephone device, including a traditional landline telephone. For example, the user may place a call to the call center in this example, and the call may be answered by a customer service representative of the organization. Generally, such customer service representatives interface with users/customers who dial into the call center via telephone while viewing account information associated with the user using a terminal or workstation associated with the particular system for the call center channel within the enterprise environment.

As the set of actions associated with one or more transactions initiated by the user within some predetermined time period in the first channel is captured and stored to a database in the enterprise network in real time, the system of the second channel (i.e., the call center in this example) can be configured to detect the occurrence of a relevant or closely related transaction from the first channel, as described above. Also, as described above, upon detection, in the second channel, of the occurrence of a relevant or closely related action of the user (step 216) in association with the relevant transaction in the first channel, the stored action or set of actions for the relevant transaction and other data can be shared, for example, via a back end system of the enterprise network to ACSS database 155, which is associated with the second sales channel in this example. Alternatively, the set of actions of the user may be stored within a user action table of database 175 of the data warehouse system that is accessible across the first and second channels in the enterprise communication network, and retrieved in a particular sales channel when a relevant action, as described above, is detected. Also, as described above, to ensure that any user action data related to a transaction that is stored for the user is still relevant for a present transaction, and also to conserve storage space in the enterprise network, this data may be stored or maintained in the enterprise network for only a temporary duration (e.g., limited to a few days).

In response to the detection of the relevant action for the user, a modified customer service interface may be presented in place of the default interface in the second channel. In the call center example, a modified screen in an enterprise customer service application may be displayed to a customer service representative who is interfacing with the customer in the subsequent transaction. The modified screen in this example would notify the customer service representative to capture the explicit reason (e.g., in the form of a reason code) for the user's initiation of a subsequent transaction that is closely related to the recent transaction in the first channel or non-completion or abandonment of the earlier self-service transaction in the first channel (e.g., automated chat channel for technical support information or a Web channel for online retail). The captured reason code in step 220 is sent along with any additional user-specific transaction data to a data server (e.g., data server 170 of FIG. 1, as described above). Such user-specific transaction data may include, for example and without limitation, user account information and information (e.g., page trail data) related to the earlier transaction that was initiated by the user in the first channel.

In an example, the data server is part of a data warehouse of the enterprise environment, including one or more data servers 170 and databases 175. For example, the reason code and other transaction data that are captured by the service representative (or captured by automated tools such as Speech to Text converters) in the enterprise application may be compiled using the data warehouse along with transaction data associated with other enterprise customers and their recent self-service transactions in a data repository or data warehouse. For example, transaction data from the different channels of the enterprise system may be delivered to the data warehouse as an hourly or daily batch file through an enterprise communication network (e.g., communication network 130 of enterprise environment 100 of FIG. 1, as described above).

In step 224, the compiled data is used to generate customer segments or groups representing different market segments or categories of customers to whom enterprise services are provided. The generated customer segments are therefore sent to the server of the first channel in step 226. The customer segments can be used to reveal common attributes associated with similar types of customers in order to provide customized services and improved customer experience based on these common attributes (step 228). For example, improved customer experience provided to the user in the first channel, in our example, may involve displaying a customized user interface related to self-service transactions in the first channel based on the particular customer segment associated with user (step 230).

As described above, subsequent user transactions may be identified based on a global identifier (ID) that identifies the particular user (or the user's browser/device). For example, the global ID may be a unique numeric value generated by web server 140, described above in the enterprise network environment based on the user's initiation of a self-service transaction. In an example, the global ID is stored at the user's device. Additionally or alternatively, the global ID may be stored in database 175 of the data warehouse in the enterprise environment, as described above. For example, the global ID may be stored in a cookie file associated with the user's web browser and also in an enterprise database accessible across multiple channels within the organization. As such, the global ID may be used to identify the particular user and the customer segment to which the user belongs for any subsequent self-service transactions initiated by the user in any of the various channels.

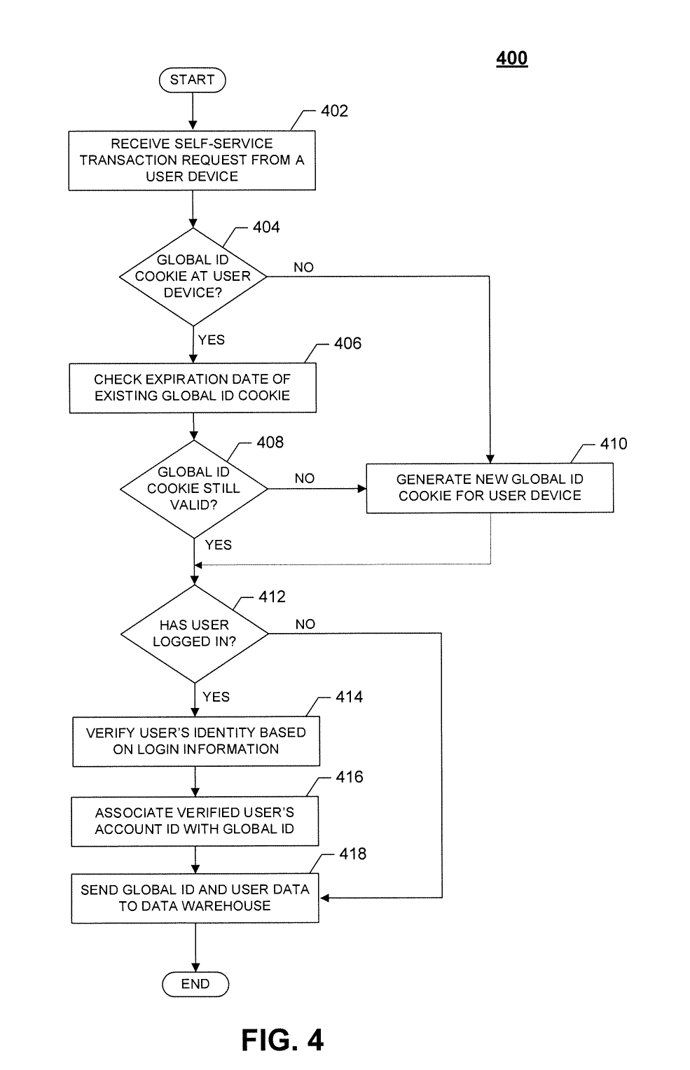

In an example, each global ID stored in an associated cookie file may include an expiration date specifying the period of time during which the global ID remains valid for the particular device or browser or other application on the device. Once a user of the device identifies herself to the enterprise (e.g., by submitting authentication information), the global ID is then linked to that particular user. Additional details related to generating and managing a global ID for a user will be described further below with respect to FIG. 4.

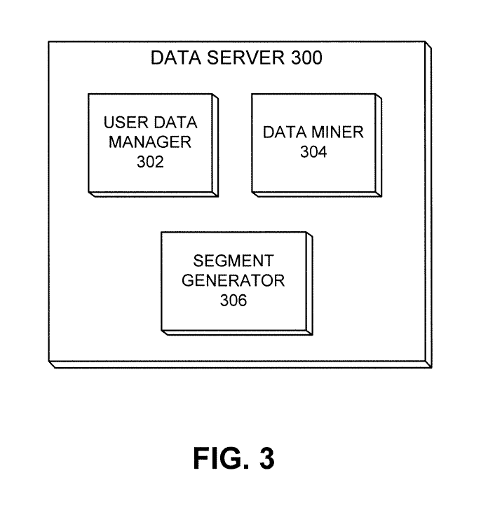

FIG. 3 is a block diagram of an exemplary data server 300 for creating customer segments based on explicit user feedback in a corrective action framework. As shown in the example of FIG. 3, data server 300 includes a user data manager 302, a data miner 304, and a segment generator 306. For ease of explanation, data server 300 is described using enterprise environment 100 of FIG. 1 and the corresponding process flowchart 200 of FIG. 2, as described above. For example, data server 300 may be implemented using data server 170 of enterprise environment 100, as shown in FIGS. 1 and 2 and described above. However, data server 300 is not intended to be limited thereto. In an example, data server 300 is associated with a data warehouse portion of an enterprise communication system (e.g., enterprise environment 100 of FIG. 1, as described above). For example, the data warehouse may be used in the enterprise system as a repository for storing user transaction data. As described above, the transaction data stored in the data warehouse may include user account information, user transaction history, and reason codes for any cross-channel self-service transactions.

In this example, user data manager 302 is configured to interface with various internal systems within the enterprise. For example, such internal systems may correspond to each of the sales or customer service channels within the organization, as described previously. User data manager 302 may be configured to interface with each of these systems on an individual basis for receiving user transaction data. Alternatively, transaction data corresponding to the various users may be compiled at a centralized database for real-time monitoring of the last or most recent actions detected for the respective users. Further, each enterprise user or customer may be identified based on a unique global identifier, as noted above and as will be described in further detail below with respect to FIG. 4.

The user and transaction information received at user data manager 302 from the different channels of the enterprise can be sent to data miner 304 for processing. For example, data miner 304 may filter and organize the data based on different reason codes, different channels, attributes of different users or some combination of all of these. As described above, such reason codes represent the explicit feedback from a user regarding a self-service transaction in one channel of the enterprise, which may have been captured during the user's interaction with a different channel. For example, the explicit reason may have been captured in the second channel by a customer service representative or via an automated response system (e.g., step 220 of process 200 of FIG. 2, as described above). Further, such an automated response system or interactive response system associated with a call center for customer service may include speech-to-text transcription features for transcribing the user's voice responses into one or more key terms or phrases. Such key terms or phrases can then be analyzed and converted or mapped to one or more corresponding reason codes for additional processing by data miner 304, as described above. It should be noted that the data miner 304 may be configured to organize the captured user and transaction information using any one or any combination of various criteria as may be necessary for a given implementation. The reason codes may be predefined by the enterprise based on prior knowledge of market segments and historical user transaction data. The transaction data can be used to reveal relevant attributes of the different types of users or customers of a commercial enterprise, as will be described below. For example, data miner 304 may further provide a user interface enabling an enterprise employee to review the captured user transaction data for further data mining in order to discover relevant details related to the services offered by the business and the different types of customers who use these services.

Accordingly, segment generator 306 is configured to generate different user or customer segments based on explicit user/customer feedback and various attributes associated with the customer. Examples of such attributes may include, but are not limited to, a user's age, gender, zip code, level of education, income, ethnicity and other similar types of information. This information may be used by segment generator 306 to identify a consumer profile for each user. The collective user profile information for all enterprise customers can then be used to generate a customer segment for each reason code. The customer segments may be generated based on various types of user data including, for example and without limitation, user account data and user attributes, as described above. Also, the customer segments may be generated based on additional third-party data, such as marketing data from a third-party marketing service employed by the enterprise for one or more channels. The customer segments generated by segment generator 306, the segment can then be relayed from data server 300 to the relevant channel(s) in the enterprise organization. For example, relevant customer segment information may be transmitted from data server 300 to an internal system (e.g., web server 140 and database 145 of enterprise environment 100, as described above), which may be associated with a channel in the enterprise network associated with one or more user cross channel transactions.

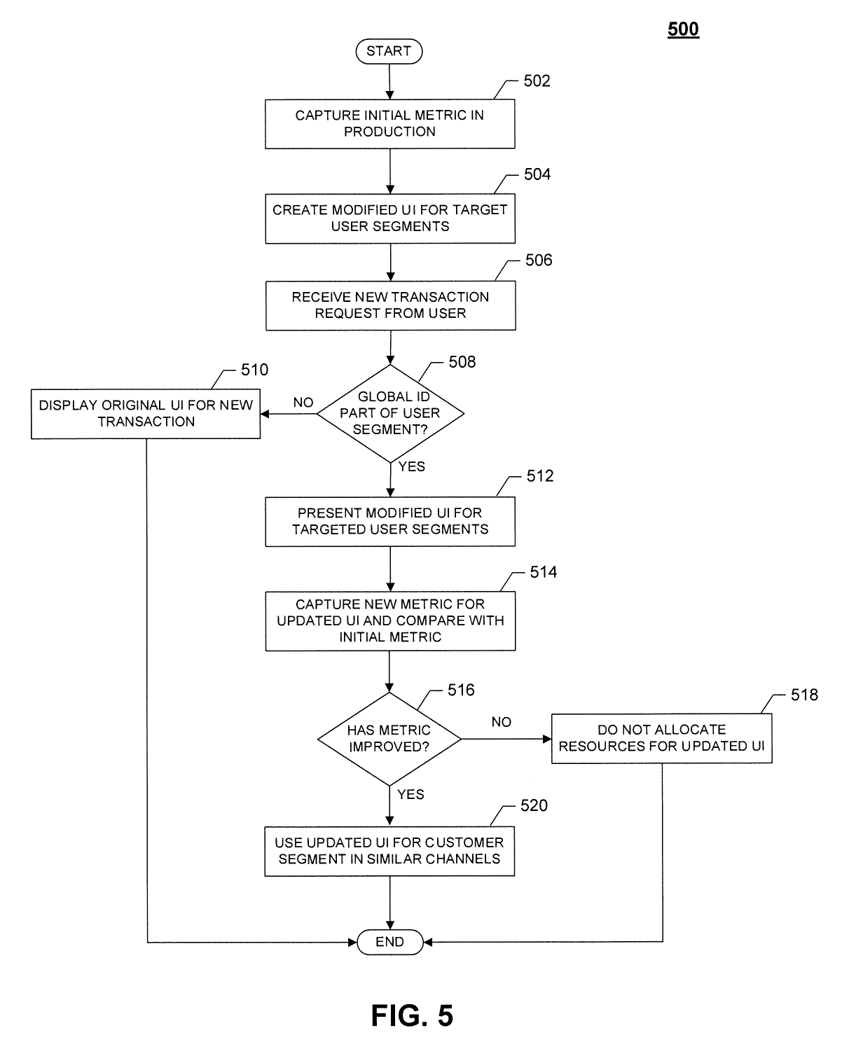

The customer segment information generated by the data warehouse system of the enterprise environment may be utilized in one or more channels to improve user experience. This will be described in further detail below with respect to process 500 of FIG. 5. The customer segments can be used to make improvements to the user interface of self-service transactions based on each customer/user segment. For example, the user interface of a self-service transaction in the channel may be customized for one or more customer segments. As such, the self-service transaction may display a customized user interface based on the customer segment identified for a particular user. As will be described in further detail below with respect to FIG. 4, a particular user or set of users of a single user device may be identified based on a global identifier associated with the user or user's browser (e.g., based on a browser cookie including the global identifier stored at the user's device). In this way, a cross-channel feedback loop is created within the enterprise environment, which can be used, for example, to improve user experience and mitigate the chances for further user-abandoned self-service transactions in a channel, particularly with respect to those transactions abandoned due to one of the explicit reasons as identified by the user and captured in the enterprise using a reason code.

FIG. 4 is a flowchart of an exemplary process 400 for identifying a user/customer across different retail channels of the enterprise based on a global identifier (ID) assigned to the user in the enterprise environment. For example, the global ID may be a unique numeric identifier used to track each user and associated actions for automated or self-service transactions across the different interactive channels of the enterprise. As such, the global ID may be a numeric value including a sufficient number of digits so as to ensure that it remains unique for each user of the business enterprise. As described above, the global ID for each user may be stored in a cookie file associated with a web browser at the user's device, and in a database within a data warehouse of the enterprise environment. Additionally, the global ID may include an expiration date, which can be used to specify some length of time (e.g., one year) during which a global ID remains valid for identifying a user's self-service transactions.

As shown in FIG. 4, process 400 begins in step 402, which includes receiving a transaction request from a user or customer of the enterprise. For example, the user may have previously initiated a self-service transaction for goods and services via an automated customer service interface of the Web retail channel of the enterprise, as described above. Further, the transaction request referred to in step 402 may be a subsequent transaction initiated by the same user in this same channel. As will be described in further detail below, the global ID associated with the particular user enables the enterprise environment to adapt the user interface presented to the user for self-service transactions in the one or more interactive channels of the enterprise providing an automated interface for self-service transactions. For example, the user interface may be adapted or customized for the particular user based on the customer segment with which the user is associated, as described above.

In step 404, it is determined whether a browser cookie file including the global ID is present at the user's device. For example, such a cookie file would be missing if this is the first time the user is initiating a self-service transaction or a previously stored cookie file has been deleted by the user or by the user's browser. If a global ID cookie is not present at the user's device, process 400 proceeds to step 410, in which a new global ID cookie is generated for the user. The generated global ID cookie can then be stored at the user's device and in a centralized database or a data warehouse of the enterprise environment in order to identify the user for subsequent self-service transactions, as described above. If a global ID is present at the user's device, process 400 proceeds to steps 406 and 408, in which the expiration date of the global ID cookie is checked to determine whether the cookie is still valid. If the cookie has expired and is therefore no longer valid, a new global ID cookie with a new expiration date can be generated in step 410.

In step 412, it is determined whether the user has logged in to the enterprise system by providing login credentials associated with the user's account. If the user has provided login credentials, the user's identity can be verified in step 414 and the enterprise system can associate the global ID with the user's previously stored account information in the enterprise system. For example, the global ID may be associated with an account ID associated with the user. The associated global ID and account ID can then be stored internally within the data warehouse of the enterprise environment (step 418). Accordingly, the particular user and other relevant information (e.g., one or more attributes) that may be associated with the user's account can be utilized for subsequent self-service transactions.

FIG. 5 is a flowchart of an exemplary process 500 for monitoring and improving production metrics associated with a modified user interface for a customer segment generated for a channel of the enterprise based on explicit customer feedback captured in a different channel, as described above. For example, the explicit customer feedback may be represented in the enterprise network environment by a reason code that was captured in one interactive channel of the enterprise (e.g., customer service call center) based on the detection of a transaction in another channel (e.g., Web retail channel). Also, as described above, the customer feedback is used to generate various customer segments, and a customized user interface may be created based on the identified attributes associated with customers in each customer segment. In an example, a customer segment may correspond to customers above a certain age group or who have poor eye sight. As such, the creation of a customized user interface for such a customer segment may include displaying text content in the interface in a larger font size relative to a default size used in a previous user interface.

Accordingly, the use of customer segments allows the user interface for self-service transactions in an interactive channel (e.g., in the form of a web page in the web retail channel) to be presented or rendered differently based on the type of user. Further, the enterprise may be able to identify or target certain customer segments that may be of particular interest. Thus, the enterprise can provide a default user interface for most users but a customized user interface for a user associated with a targeted customer segment. In an example, the enterprise can gauge the effectiveness of a modified or customized user interface by comparing different production metrics associated with the original user interface relative to the new user interface, created based on explicit user feedback. As will be described in further detail below, these metrics can be used to make various modifications, adjustments or improvements to the user interface or user experience provided for a transaction in a channel of the enterprise. It is noted that such modifications or improvements to the user interface or user experience for a channel are not limited to front-end user interface (UI) modifications and may include any new or modified back-end process or operation for a system in the enterprise that is associated with a self-service transaction. In a particular example, such a modification may include automatically sending, to the user's mobile device, a text or multimedia message including a confirmation of a completed transaction in any channel of the enterprise. Further, the modifications or improvements may be implemented in an iterative fashion to further improve user experience based on explicit user feedback and also, to increase the likelihood of a desired outcome related to business goals for one or more targeted customer segments.

As shown in FIG. 5, in step 502 of process 500, an initial metric associated with the original user interface in production is captured. Step 504 corresponds to the creation of a modified user interface/experience for targeted customer segments, as previously described. When a transaction request is received from the user to initiate a self-service transaction via the modified user interface for a channel of the enterprise (step 506), the presence of a global ID cookie at the user's device is checked, as described above with respect to process 400 of FIG. 4. In step 508, if a valid global ID is present at the user's device and this global ID is determined to be a part of or associated with any user segment or a user segment that may be particularly targeted (e.g., for marketing purposes), a modified user experience including a modified user interface (UI) is presented to the user for the self-service transaction in step 512. The modified UI and user experience is used for at least the current session of the self-service transaction in place of the original or default user interface and user experience used previously. However, if a previously stored global ID is not found at the user device or the global ID is not associated with a targeted user segment, the original user interface and user experience is provided for the transaction in step 510.

Assuming a valid global ID is available for the current transaction and it is associated with a targeted customer segment, the usage and effectiveness of the modified user interface and/or modified user experience is then tested in step 514. As described above, the effectiveness of the modified user interface and/or modified user experience may be tested by capturing a new metric associated with this new interface in production and comparing this metric with the initial metric captured earlier in step 502. Therefore, step 516 includes determining whether the metrics associated with a modified UI have improved over previous metrics associated with prior versions of the user interface and/or user experience. If the metrics have improved from prior versions, then the updated UI and/or user experience may be implemented on a permanent basis for one or more of the channels of the enterprise as appropriate (step 520). However, if no improvement has been identified, the enterprise can switch back to a prior version of the UI and user experience and therefore, not allocate any further resources for the updated UI (step 518).

A production metric that may be used to test the relative effectiveness of a modified user interface (e.g., web page) or modified back end process (e.g. sending email confirmation of transaction) may include, for example and without limitation, a conversion rate representing the number of times (or number of users) that a previously abandoned transaction is later completed successfully following the introduction of a modified user interface/experience. Other examples of metrics that can be used may include, but are not limited to, the number of times a user views or visits a web page, e.g., associated with a user interface of a self-service transaction of a web retail channel, the length of time spent for each visit, the number of different users who visit the page, and other types of information related to the amount of web traffic that the page receives during some period of time. It should be noted that any one of various well-known third-party commercial solutions may be used as desired in the enterprise environment for monitoring and capturing such metric data. For example, metrics corresponding to the web traffic for a web site of a web or online interactive channel can be used to optimize the web site based on the business goals of the enterprise. Such business goals may include, for example, increasing visits to a page, selling more products or product accessories, or promoting certain kinds of self-service transactions.

In an example, one or more conversion paths may be identified based on these metrics. The conversion paths may be designed to increase the probability for attaining a successful conversion event (e.g., conversion of user action from abandonment to successful completion of the transaction). In addition, a change plan may be implemented based on such a conversion path, for example, in a web channel. In a further example, the different conversion paths that have been identified can be analyzed to make relative comparisons in regard to the effectiveness of each path. For example, a path analysis report may be generated for each conversion path based on captured production metrics. Each report may show, for example, the number of users who abandoned the self-service transaction and the particular point at which it was abandoned. It is noted that while such reports provide useful information for gauging the effectiveness of a particular user interface relative to others, the most useful information may be the explicit feedback from the user, as previously described.

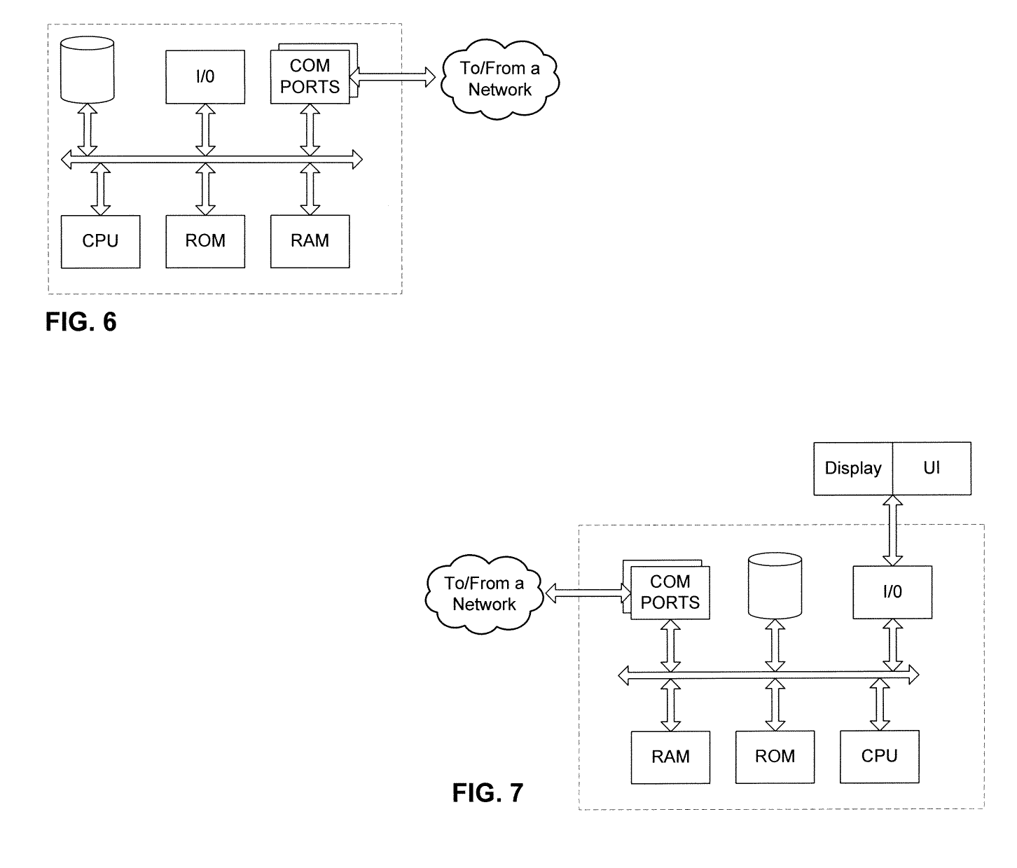

FIGS. 6 and 7 provide functional block diagram illustrations of general purpose computer hardware platforms. FIG. 6 illustrates a network or host computer platform, as may typically be used to implement a server (e.g., servers 140, 150, 160 or 170 and the respective databases 145, 155, 165 or 175 of FIG. 1 and data server 300 of FIG. 3, as described above). FIG. 7 depicts a computer with user interface elements, as may be used to implement a personal computer or mobile device (e.g., devices 110 or 120 of FIG. 1, as described above). It is believed that the structure, programming and general operation of such computer equipment is well-known in the relevant art given this description and as a result, the examples illustrated in FIGS. 6 and 7 should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that such components are generally well-known in the relevant art given the description herein. Of course, the server functions may be implemented in a distributed fashion on a number of similar platforms, to distribute the processing load.

Hence, aspects of the methods of processes 200, 400 and 500 of FIGS. 2, 4 and 5, respectively, as described above, may be embodied in programming. Program aspects of the technology may be thought of as “products” or “articles of manufacture” typically in the form of executable code or process instructions and/or associated data that is stored on or embodied in a type of machine readable medium for use by the systems implementing the interactive user channels of an enterprise and associated cross-channel feedback. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the enterprise environment into the computer platform of the enterprise server that will be hosting the user interface associated with an interactive channel.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as “computer” or “machine readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the steps of 200, 400 and 500 of FIGS. 2, 4 and 5, respectively, as described above. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

As noted above, the computer as illustrated in the example of FIG. 7 may be a mobile computer with user interface elements, as may be used to implement a laptop, tablet or notebook computer or the like. For example, such a device may include a touch-screen display for user input and output. Alternatively, the device may include a standard light emitting diode (LED) display and, for example, an alphanumeric keypad or T9 keyboard. The structure, programming, and general operation of such computing equipment are well-known and as a result, the drawing should be self-explanatory. As known in the data processing and communications arts, a mobile computer comprises a central processor or other processing device, an internal communication bus, various types of memory or storage media (RAM, ROM, EEPROM, cache memory, disk drives, etc.) for code and data storage, and one or more network interface cards or ports for communication purposes. Also, the mobile computer can further comprise various wireless transceiver modules (or components) such as GPS, WiFi, IrDA, Bluetooth, etc. The software functionalities involve programming, including executable code, associated stored data, and graphical user interface code for implementing a client application program at the mobile device. The software code is executable by the processor of the mobile computer. In operation, the code is stored within the mobile computer. At other times, however, the software may be stored at other locations and/or transported for loading into the appropriate mobile computer. Execution of such code by a processor of the mobile computer enables the mobile computer to implement the steps of processes 200, 400 and 500 of FIGS. 2, 4 and 5, respectively, in essentially the manner performed in the implementation discussed and illustrated herein.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
storing transaction data related to a first transaction between a user and an enterprise for products or services offered by the enterprise, the first transaction implemented via an automated service interface of a first channel of the enterprise provided to the user, the stored transaction data including a set of actions performed by the user via the automated service interface;
determining whether a second transaction between the user and the enterprise is related to the first transaction, the second transaction implemented via a second channel of the enterprise or via an automated service interface of the second channel;
in response to determining that the second transaction is related to the first transaction, detecting a relevant action from the set of actions;
capturing from the user, in the second channel or the automated service interface of the second channel, an explicit reason for the user's performance of the relevant action; and
determining whether to modify at least a portion of the automated service interface of the first channel based on the stored transaction data and the explicit reason.

2. A method, comprising:
providing an automated service interface to a user, via automated communication with the user through a network, of a first channel of an enterprise, the automated service interface including a series of actions for the user to perform in order to complete a transaction for products or services offered by the enterprise;
in response to a transaction request from the user for the products or services via the automated service interface, detecting a set of actions performed by the user via the automated service interface;
storing transaction data related to the transaction, the stored transaction data specifying the set of actions;
in response to a subsequent transaction request received from the user through the network via a second channel of the enterprise or an automated service interface of the second channel, detecting a relevant action from the set of actions;
capturing from the user, in the second channel or the automated service interface of the second channel, an explicit reason for the relevant action; and
determining whether to modify at least a portion of the automated service interface of the first channel based on the stored transaction data and the explicit reason.

3. The method of claim 2, wherein the transaction data includes a unique global identifier identifying the user across the first and second channels of the enterprise.

4. The method of claim 2, wherein the explicit reason is captured in the form of a reason code selected from a plurality of reason codes.

5. The method of claim 2, wherein the modifying step further comprises:
identifying one or more attributes for the user based on the stored transaction data; and
assigning the user to a predetermined user segment based on the identified attributes and the explicit reason, the predetermined user segment associated with at least one other user having attributes similar to that of the user.

6. The method of claim 2, wherein the transaction data includes account information and information corresponding to a device used by the user to access the automated interface of the first channel of the enterprise.

7. The method of claim 2, wherein the first channel is any of and the second channel is a different one of: a Web channel, an interactive voice response channel, a handset channel, a physical retail store channel, an automated kiosk channel, a live-person chat channel, an automated chat channel and a telesales channel.

8. The method of claim 2, wherein the transaction data stored in response to the set of actions corresponds to a set of transactions, and detecting the relevant action includes detecting a relevant transaction from the set of transactions, and detecting the relevant action for the relevant transaction.

9. The method of claim 8, wherein the relevant transaction is an abandoned transaction or a closely related transaction relative to the subsequent transaction.

10-21. (canceled)

22. A server, comprising:
at least one processor; and
a memory coupled to the processor, the memory including processor-readable instructions that when executed by the processor configures the processor to perform functions, including functions to:
store transaction data related to a first transaction between a user and an enterprise for products or services offered by the enterprise, the first transaction implemented via an automated service interface of a first channel of the enterprise provided to the user, the stored transaction data including a set of actions performed by the user via the automated service interface;
determine whether a second transaction between the user and the enterprise is related to the first transaction, the second transaction implemented via a second channel of the enterprise or via an automated service interface of the second channel;
detect a relevant action from the set of actions, based on the determination that the second transaction is related to the first transaction;
capture from the user, in the second channel or the automated service interface of the second channel, an explicit reason for the user's performance of the relevant action; and
determine whether to modify at least a portion of the automated service interface of the first channel based on the stored transaction data and the explicit reason.

23. A non-transitory, tangible computer-readable storage medium having computer programming instructions stored therein that when executed by a computer processing system causes the computer processing system to perform functions, including functions to:
provide an automated service interface to a user, via automated communication with the user through a network, of a first channel of an enterprise, the automated service interface including a series of actions for the user to perform in order to complete a transaction for products or services offered by the enterprise;
detect a set of actions performed by the user via the automated service interface, in response to a transaction request from the user for the products or services via the automated service interface;
store transaction data related to the transaction, the stored transaction data specifying the set of actions;
in response to a subsequent transaction request received from the user through the network via a second channel of the enterprise or an automated service interface of the second channel, detect a relevant action from the set of actions;
capture from the user, in the second channel or the automated service interface of the second channel, an explicit reason for the relevant action; and
determine whether to modify at least a portion of the automated service interface of the first channel based on the stored transaction data and the explicit reason.

24. The computer-readable storage medium of claim 23, wherein the transaction data includes a unique global identifier identifying the user across the first and second channels of the enterprise.

25. The computer-readable storage medium of claim 23, wherein the explicit reason is captured in the form of a reason code selected from a plurality of reason codes.

26. The computer-readable storage medium of claim 23, wherein the report function includes functions to:
identify one or more attributes for the user based on the stored data about the stored transaction data; and
assign the user to a predetermined user segment based on the attributes identified for the user and the explicit reason, the predetermined user segment associated with at least one other user having attributes similar to that of the user.

27. The computer-readable storage medium of claim 23, wherein the stored transaction data includes account information and information corresponding to a device used by the user to access the automated service interface of the first channel.

28. The computer-readable storage medium of claim 23, wherein the first channel of the enterprise is any of and the second channel of the enterprise is a different one of: a Web channel, an interactive voice response channel, a handset channel, a physical retail store channel, an automated kiosk channel, a live-person chat channel and a telesales channel.

29. The computer-readable storage medium of claim 23, wherein the relevant action is an abandonment of the transaction before completion of the transaction via the first channel, the stored transaction data is related to the abandoned transaction and the set of actions specified by the stored transaction data relates to completion of the abandoned transaction via an interface of the second channel, and the computer processing system is further configured to perform functions to:
correlate the subsequent transaction request received from the user through the network via the second channel with the stored transaction data related to the abandoned transaction;
collect, via the interface of the second channel, feedback from the user about the automated service interface of the first channel for the abandoned transaction;
determine whether to modify at least one operation of the automated service interface of the first channel based on the feedback collected from the user; and
report the feedback collected from the user to the first channel for determining whether to modify at least one operation of the automated service interface.

30. The computer-readable storage medium of claim 29, wherein:
the data about the abandoned transaction includes a unique global identifier identifying the user across the first and second channels, and
the feedback from the user about the automated service interface of the first channel is collected via the interface of second channel in the form of a reason code selected from a plurality of reason codes.

31. The computer-readable storage medium of claim 29, wherein the report function includes functions to:
identify one or more attributes for the user based on the stored data about the abandoned transaction; and
assign the user to a predetermined user segment based on the attributes identified for the user and the feedback collected from the user via the interface of the second channel, the predetermined user segment associated with at least one other user having attributes similar to that of the user.

32. The computer-readable storage medium of claim 29, wherein the stored transaction data related to the abandoned transaction includes account information and information corresponding to a device used by the user to access the automated service interface of the first channel.

33. The computer-readable storage medium of claim 29, wherein the first channel of the enterprise is any of and the second channel of the enterprise is a different one of: a Web channel, an interactive voice response channel, a handset channel, a physical retail store channel, an automated kiosk channel, a live-person chat channel and a telesales channel.
